(19) United States
(12) Patent Application Publication
(10) Pub. No.: US 2020/0219047 A1
(43) Pub. Date: Jul. 9, 2020

(54) METHODS OF COORDINATING CONSUMER DELIVERY

(71) Applicant: Haier US Appliance Solutions, Inc., Wilmington, DE (US)

(72) Inventor: Steven Keith Root, Buckner, KY (US)

(21) Appl. No.: 16/238,647

(22) Filed: Jan. 3, 2019

(51) Int. Cl. G06Q 10/08; G06Q 10/06; G09B 19/00

(52) U.S. Cl. CPC G06Q 10/0832; G09B 19/003; G06Q 10/067

(57) ABSTRACT

Methods of coordinating consumer delivery are provided herein. The methods may include receiving an order signal indicating a plurality of programmed product units, and simulating, apart from a destination container, the plurality of programmed product units within a storage chamber of the destination container. The methods may further include determining, apart from the destination container, an arrangement of the plurality of programmed product units for the storage chamber based on simulating the plurality of programmed product units. The methods may still further include generating instructions for the determined arrangement of the plurality of programmed product units.

### FIELD OF THE INVENTION

The present subject matter relates generally to delivery methods for multiple packages or items, and more particularly to improved delivery methods for coordinating delivery of items at or to a consumer's home or residence.

### BACKGROUND OF THE INVENTION

Purchasing goods or products remotely, such as from individual Internet retailers or aggregating delivery providers, is becoming increasingly popular with consumers. Convenience and economies of scale often motivate consumers to shop and pay for items without ever visiting a physical store. Items such as clothes, appliances, and perishable food items are all being purchased and delivered in greater numbers throughout much of the world. In some instances, those items can be delivered in a matter of days or even hours.

Although the increase in remote shopping provides numerous benefits to consumers, certain difficulties are also caused or exacerbated by the increase. For instance, retailers and delivers have been forced to address the unpredictability that is common with increased remote shopping. Often the size, frequency, and care instructions can vary wildly based on the item being delivered. This can lead to difficulties in how an item or items may be transported and ultimately delivered to the consumer. However, coordinating delivery with the consumer becomes a greater concern, especially when a delivery includes items that cannot simply be left outdoors or on the doorstep of the consumer's residence. Moreover, with the increased number of deliveries being made to consumers' residences, there may be a greater concern or opportunity for thefts to occur.

Attempts have been made to address some of the above issues by simply delivering to a remote nonresidential location, such as a locker. However, this can greatly decrease the convenience that is typically associated with remote shopping. Moreover, it is often difficult for a consumer, retailer, or delivery provider to know if multiple items will fit within a locker prior to delivery. This may cause frustration for consumers, and increased expenses for the retailer or delivery provider. Some have suggested granting retailers or delivery providers direct access to consumers' residences or buildings. However, the privacy and safety concerns for this are self-evident.

As a result, it would be useful to provide an improved method of consumer delivery. In particular, it would be advantageous to provide a method of coordinated delivery that addresses one or more of the above issues.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of coordinating consumer delivery is provided. The method may include receiving an order signal indicating a plurality of programmed product units, and simulating, apart from a destination container, the plurality of programmed product units within a storage chamber of the destination container. The method may further include determining, apart from the destination container, an arrangement of the plurality of programmed product units for the storage chamber based on simulating the plurality of programmed product units. The method may still further include generating instructions for the determined arrangement of the plurality of programmed product units.

In another exemplary aspect of the present disclosure, a method of coordinating consumer delivery is provided. The method may include receiving an order signal indicating a plurality of programmed product units, and simulating, apart from a destination container, the plurality of programmed product units within a storage chamber of the destination container. The method may further include determining, apart from the destination container, an arrangement of the plurality of programmed product units for the storage chamber based on simulating the plurality of programmed product units. The method may still further include confirming capacity to receive the plurality of programmed product units within the storage chamber in response to determining the arrangement, and generating instructions for the determined arrangement of the plurality of programmed product units.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side plan view of a destination container according to exemplary embodiments of the present disclosure.

FIG. 2 provides a schematic view of the exemplary destination container of FIG. 1.

FIG. 3 provides a schematic view of a delivery system according to exemplary embodiments of the present disclosure.

FIG. 4 provides a flow chart illustrating a method of coordinated delivery in accordance with exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

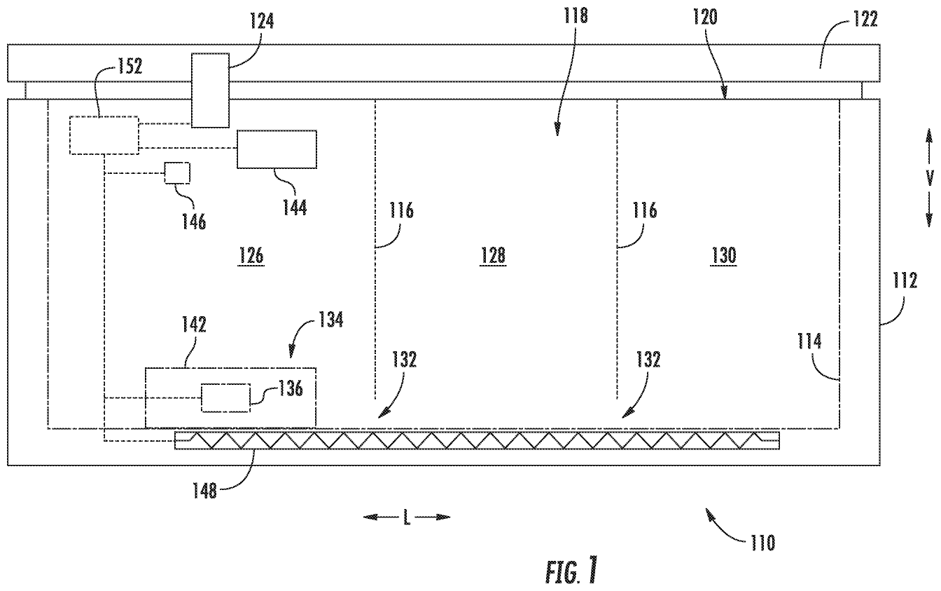

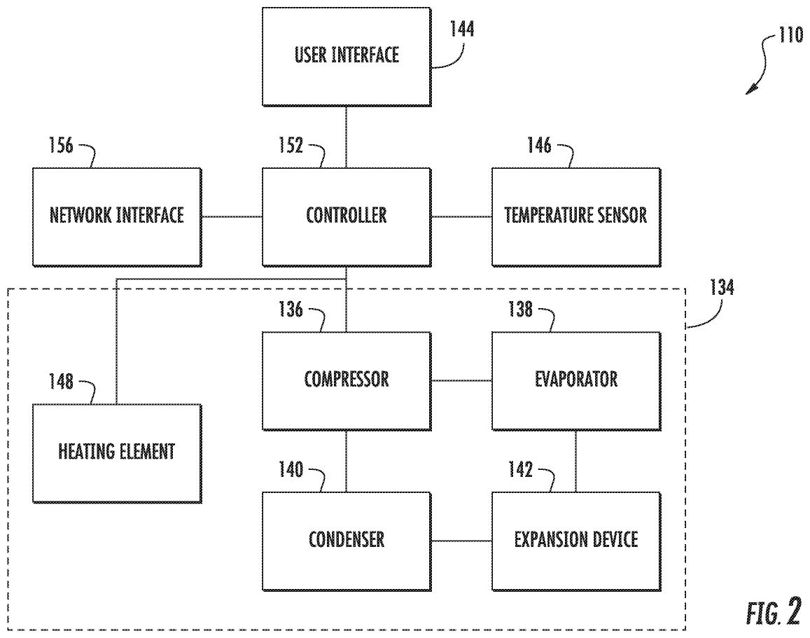

Turning now to the figures, FIGS. 1 and 2 provide various views of a destination container 110 according to exemplary embodiments of the present disclosure. Generally, destination container 110 may be installed or mounted (e.g., fixed to the ground or floor) outside of a consumer's residence or building for selective access by a delivery agent.

As shown, destination container 110 includes a cabinet 112 the generally defines a mutually-orthogonal vertical direction V, lateral direction L, and transverse direction. When assembled, one or more walls of cabinet 112 define a storage chamber 118 (e.g., as a partially enclosed volume) within which one or more packages or delivered product units may be stored, such as when a delivery agent has arrived at a consumer's residence while the consumer is absent or otherwise unavailable to receive a delivery directly. Thus, an opening 120 is generally defined by cabinet 112 in communication with storage chamber 118 (e.g., such that packages or delivered product units may be selectively inserted into or removed from storage chamber 118 through the opening 120). A door 122 may be movably (e.g., rotatably) attached to cabinet 112 to selectively move between an open position (not pictured) and a closed position (FIG. 1). In the open position, door 122 may be generally rotated or moved away from the opening 120 such that access to storage chamber 118 is permitted. By contrast, in the closed position, door 122 may cover the opening 120, and thereby restrict access to storage chamber 118. In optional embodiments, a lock assembly 124 is provided to selectively hold door 122 in the closed position. As is understood, lock assembly 124 may be provided as any suitable selectively locking mechanism (e.g., catch-latch assembly, receiving cavity-tumbler, etc.) and may be controlled by, for instance, a controller 152 of destination container 110.

Generally, storage chamber 118 is defined, at least in part, by one or more internal liners 114 of cabinet 112. In some embodiments, one or more divider liners 116 are be provided to separate storage chamber 118 into multiple discrete compartments 126, 128, 130. The divider liners 116 may be fixed within storage chamber 118 or, alternatively, selectively movable such that the size or volume of specific compartments 126, 128, 130 may be varied (e.g., even when the overall volume of the storage chamber 118 remains constant). In optional embodiments, storage chamber 118 includes multiple discrete, temperature varied compartments. For instance, storage chamber 118 may include a freezer compartment 126 (e.g., generally maintained at a constant temperature or temperature range below 0° Celsius or −18° Celsius) and a fresh food compartment 128 (e.g., generally maintained at a constant temperature or temperature range between 1° Celsius and 7° Celsius). Additionally or alternatively, storage chamber 118 may include a room temperature compartment 130 (e.g., generally maintained at a constant temperature or temperature range between 18° Celsius and 24° Celsius). In some embodiments, a common channel 132 is defined (e.g., through an adjacent or shared divider liner 116) to permit the fluid communication (e.g., exchange) of air between adjacent compartments.

In exemplary embodiments, a conditioning assembly 134 is mounted to cabinet 112 (e.g., within the walls of cabinet 112) to selectively cool, heat, or otherwise regulate the temperature of storage chamber 118. Thus, conditioning assembly 134 is provided in thermal communication with at least a portion of storage chamber 118.

As shown, certain embodiments of conditioning assembly 134 include a sealed cooling system for executing a vapor compression cycle for cooling air items or air within storage chamber 118. The sealed cooling system of conditioning assembly 134 may include a compressor 136, a condenser 138, an expansion device 140, and an evaporator 142 connected in fluid series and charged with a refrigerant. As will be understood by those skilled in the art, the sealed cooling system may include additional components (e.g., at least one additional evaporator, compressor, expansion device, or condenser). Moreover, evaporator 142 is provided in thermal communication with storage chamber 118 to cool the air or environment within storage chamber 118. Optionally, evaporator 142 is mounted within freezer compartment 126, as generally illustrated in FIG. 1.

Within conditioning assembly 134, gaseous refrigerant flows into compressor 136, which operates to increase the pressure of the refrigerant. This compression of the refrigerant raises the refrigerant temperature, which is lowered by passing the gaseous refrigerant through condenser 138. Within condenser 138, heat exchange (e.g., with ambient air takes place) to cool the refrigerant and cause the refrigerant to condense to a liquid state.

Expansion device 140 (e.g., a mechanical valve, capillary tube, electronic expansion valve, or other restriction device) receives liquid refrigerant from condenser 138. From expansion device 140, the liquid refrigerant enters evaporator 142. Upon exiting expansion device 140 and entering evaporator 142, the liquid refrigerant drops in pressure and vaporizes. Due to the pressure drop and phase change of the refrigerant, evaporator 142 is cool relative to at least a portion of storage chamber 118 (e.g., freezer compartment 126). As such, cooled air is produced and refrigerates freezer compartment 126. Thus, evaporator 142 is a heat exchanger which transfers heat (e.g., from air passing over evaporator 142 to refrigerant flowing through evaporator 142).

In certain embodiments, conditioning assembly 134 is generally configured to heat at least a portion of storage chamber 118. As an example, the sealed cooling system or compressor 136 may be configured to function as a heat pump (e.g., according to a reverse refrigeration cycle). As an additional or alternative example, conditioning assembly 134 may include one or more heating elements 148 mounted on or within cabinet 112. For instance, a heating element 148 may be provided as any suitable heater (e.g., resistive heating element, gas heating element, radiant heating element, etc.) in thermal communication with storage chamber 118 to selectively heat a portion thereof. Heating element 148 may thus be activated to selectively generate heat within cabinet 112 (e.g., when air within storage chamber 118 falls below a predetermined threshold).

In some embodiments, a user interface panel 144 is provided for controlling one or more settings or features of destination container 110. For example, user interface panel 144 may include a plurality of user inputs (not labeled), such as a touchscreen or button interface, for selecting a desired setting, action, or mode of operation. Operation of destination container 110 can be regulated by a controller 152 that is operatively coupled to or in wireless communication with user interface panel 144 or various other components, as will be described below. In optional embodiments, user interface panel 144 provides selections for user manipulation of the operation of conditioning assembly 134 such as, for example, selections regarding chamber temperature, compartment arrangement, or other various options. In additional or alternative embodiments, user interface panel 144 includes a display component, such as a digital or analog display in communication with controller 152 and configured to provide operational feedback to a user (e.g., consumer). In certain embodiments, user interface panel 144 represents a general purpose I/O (“GPIO”) device or functional block.

In response to user manipulation of user interface panel 144 or one or more sensor signals (e.g., temperature signals received from a temperature sensor 146 mounted in thermal communication with storage chamber 118), controller 152 may operate various components of conditioning assembly 134 or destination container 110 in general.

As shown, controller 152 is communicatively coupled (i.e., in operable communication) with user interface panel 144. Controller 152 may also be communicatively coupled with various operational components of destination container 110 as well, such as lock assembly 124, sensors (e.g., temperature sensor 146), etc. Input/output (“I/O”) signals may be routed between controller 152 and the various operational components of destination container 110. Thus, controller 152 can selectively activate and operate these various components. Various components of destination container 110 are communicatively coupled with controller 152 via one or more communication lines such as, for example, conductive signal lines, shared communication busses, or wireless communications bands.

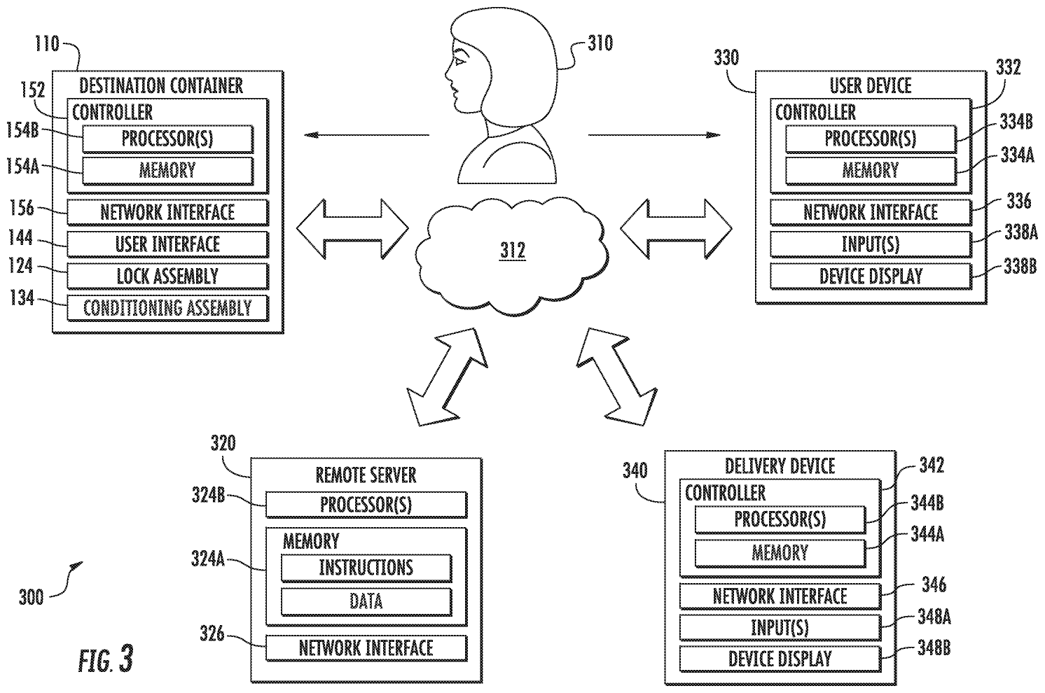

In some embodiments, controller 152 includes one or more memory devices 154A and one or more processors 154B (FIG. 3). Processors 154B can be any suitable processing device (e.g., a processor core, a microprocessor, an ASIC, a FPGA, a microcontroller, etc.) and can be one processor or a plurality of processors 154B that are operatively connected. When assembled, processors 154B can generally execute programming instructions or control code associated with operation of destination container 110. Memory devices 154A can include one or more non-transitory computer-readable storage mediums, such as RAM, ROM, EEPROM, EPROM, flash memory device, magnetic disks, etc., and combinations thereof. Memory devices 154A can store data and processor instructions that are executed by processors 154B to cause destination container 110 to perform operations. For example, processor instructions could be directives or processor actions for activating or controlling conditioning assembly 134, lock assembly 124, or user interface panel 144. Memory devices 154A may also include data, such as approved identification data, received instruction data, etc., that can be retrieved, manipulated, created, or stored by processors 154B.

Generally, controller 152 can be positioned in any suitable location throughout cabinet 112. For example, controller 152 may be located proximate to user interface panel 144 toward a front portion of destination container 110.

In certain embodiments, controller 152 includes a network interface 156 (FIG. 3) such that controller 152 can connect to and communicate over one or more networks (e.g., network 312—FIG. 3) with one or more network nodes. Controller 152 can also include one or more transmitting, receiving, or transceiving components for transmitting/receiving communications with other devices communicatively coupled with destination container 110. Additionally or alternatively, one or more transmitting, receiving, or transceiving components can be located off board controller 152.

Turning especially to FIG. 3, a schematic view of a system 300 for coordinated delivery of one or more packages or product units. For instance, the product units may be product units from that are offered for sale or delivery by a remote party (e.g., retailer or delivery provider) to a consumer or user 310 at whose building or residence destination container 110 is mounted. As would be understood, information regarding the product units offered for sale or delivery (e.g., information regarding size, mass, volume, recommended storage temperature, etc., including the packaging for such units) may be known and programmed within one or more nodes of system 300. Thus, the product units may be described as programmed product units.

As shown, destination container 110 can be communicatively coupled with network 312 and various other nodes, such as a remote server 320, delivery device 340 of a delivery agent, or user device 330. Moreover, one or more users 310 can be in operative communication with destination container 110 for by various methods, including voice control, gesture recognition, interaction with user interface panel 144, or through an intermediate device (e.g., user device 330). Additionally or alternatively, although network 312 shown, destination container 110, remote server 320, user device 330, delivery device 340 or other devices within system 300 need not be communicatively coupled via network 312; rather, destination container 110 and various other devices of system 300 can be communicatively coupled via any suitable wired or wireless means not over network 312, such as, for example, via physical wires, transceiving, transmitting, or receiving components.

Network 312 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 312 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, a remote server 320, such as a web server, is in operable communication with destination container 110. Remote server 320 can be used to host a remote retail or delivery platform. In other words, remote server 320 may be server that hosts or operates the website or web-based application for a remote retailer or delivery provider. Additionally or alternatively, remote server 320 can be used to host an information database (e.g., delivery database or programmed product information database). Remote server 320 can be implemented using any suitable computing device(s). Remote server 320 may include one or more processors 324B and one or more memory devices 324A (i.e., memory). Processors 324B can be any suitable processing device (e.g., a processor core, a microprocessor, an ASIC, a FPGA, a microcontroller, etc.) and can be one processor or a plurality of processors that are operatively connected. Memory devices 324A can include one or more non-transitory computer-readable storage mediums, such as RAM, ROM, EEPROM, EPROM, flash memory devices, magnetic disks, etc., and combinations thereof. Memory devices 324A can store data and processor instructions that are executed by processors 324B to cause remote server 320 to perform operations. For example, processor instructions could be directives or processor actions for simulating positioning or placement of multiple programmed product units (e.g., items that are available for sale or delivery from the retailer or delivery provider to a consumer or user 310) within destination container 110, simulating a temperature distribution within destination container 110, receiving/transmitting identification signals, transmitting/receiving instruction signals, etc.

The memory devices 324A may also include data, such as data relating to the programmed product units (e.g., size, mass, volume, recommended storage temperature, etc.), data relating to destination container 110 (e.g., dimensions or volume of storage chamber 118, including compartments thereof), etc., that can be retrieved, manipulated, created, or stored by processors 324B. The data can be stored in one or more databases. The one or more databases can be connected to remote server 320 by a high bandwidth LAN or WAN, or can also be connected to remote server 320 through network 312. The one or more databases can be split up so that they are located in multiple locales.

Remote server 320 includes a network interface 326 such that remote server 320 can connect to and communicate over one or more networks (e.g., network 312) with one or more network nodes. Network interface 326 can be an onboard component or it can be a separate, off board component. In turn, remote server 320 can exchange data with one or more nodes over network 312. In particular, remote server 320 can exchange data with destination container 110. Additionally or alternatively, it is understood that remote server 320 may further exchange data with any number of client devices (e.g., a user device 330, a delivery device 340, etc.) over network 312.

In certain embodiments, a user device 330 is communicatively coupled with network 312 such that user device 330 can communicate with destination container 110. For instance, user device 330 may communicate directly with destination container 110 via network 312. Additionally or alternatively, user device 330 can communicate indirectly with destination container 110 by communicating via network 312 with remote server 320, which in turn communicates with destination container 110 via network 312. Moreover, user 310 can be in operative communication with user device 330 such that user 310 can communicate with destination container 110 via user device 330.

User device 330 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 330 can include one or more user device controllers 332. Controller 332 can include one or more processors 334B and one or more memory devices 334A. Processors 334B can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and processor instructions that are executed by processors 334B to cause user device 330 to perform operations. Controller 332 may include a user device network interface 336 such that user device 330 can connect to and communicate over one or more networks (e.g., network 312) with one or more network nodes. Network interface 336 can be an onboard component of controller 332 or it can be a separate, off board component. Controller 332 can also include one or more transmitting, receiving, or transceiving components for transmitting/receiving communications with other devices communicatively coupled with user device 330. Additionally or alternatively, one or more transmitting, receiving, or transceiving components can be located off board controller 332.

User device 330 can include one or more user inputs 338A such as, for example, buttons, one or more cameras, or a touch screen interface. Additionally or alternatively, user device 330 can include a device display 338B configured to display graphical user interfaces or other visual representations to user 310. For example, display can display graphical user interfaces corresponding to operational features (e.g., temperature settings or activation/deactivation of lock assembly 124) of destination container 110 such that user 310 may manipulate or select the features to operate destination container 110. Optionally, device display 338B can be a touch sensitive component (e.g., a touch-sensitive display screen or a touch pad) that is sensitive to the touch of a user input object (e.g., a finger or a stylus). For example, a user 310 may touch the device display 338B with his or her finger and type in a series of numbers on the display 338B. In addition, motion of the user input object along or relative to the display 338B can enable user 310 to provide input to user device 330. As is understood, user device 330 may provide other suitable methods for providing input to user device 330 as well. Moreover, user device 330 can include one or more speakers, one or more cameras, or more than one microphones such that user device 330 configured with voice control, motion detection, or other functionality.

In additional or alternative embodiments, a delivery device 340 is communicatively coupled with network 312 such that delivery device 340 can communicate with remote server 320 or destination container 110. For instance, delivery device 340 may communicate directly with destination container 110 via network 312. Additionally or alternatively, delivery device 340 can communicate indirectly with destination container 110 by communicating via network 312 with remote server 320, which in turn communicates with destination container 110 via network 312. Moreover, a delivery agent can be in operative communication with delivery device 340 such that the delivery agent can communicate with destination container 110 via delivery device 340 (e.g., to provide a secure digital key for unlocking lock assembly 124).

Delivery device 340 may generally be carried or otherwise utilized by a delivery agent during delivery of one or more product units to destination container 110. Moreover, delivery device 340 can be any type of device, such as, for example, a personal computing device (e.g., laptop), a mobile computing device (e.g., smartphone or tablet), a wearable computing device, an embedded computing device, a remote, or any other suitable type of mobile computing device. Delivery device 340 can include one or more delivery device controllers 342. Controller 342 can include one or more processors 344B and one or more memory devices 344A. Processors 344B can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and processor instructions that are executed by processors 344B to cause delivery device 340 to perform operations. Controller 342 may include a delivery device network interface 346 such that delivery device 340 can connect to and communicate over one or more networks (e.g., network 312) with one or more network nodes. Network interface 346 can be an onboard component of controller 342 or it can be a separate, off board component. Controller 342 can also include one or more transmitting, receiving, or transceiving components for transmitting/receiving communications with other devices communicatively coupled with delivery device 340. Additionally or alternatively, one or more transmitting, receiving, or transceiving components can be located off board controller 342.

Delivery device 340 can include one or more user inputs 348A such as, for example, buttons, one or more cameras, or a touch screen interface. Additionally or alternatively, delivery device 340 can include a device display 348B configured to display graphical user interfaces or other visual representations to user 310. For example, display 348B can display graphical user interfaces corresponding to operational features (e.g., temperature settings or activation/deactivation of lock assembly 124) of destination container 110 such that a delivery agent may manipulate or select features to operate destination container 110. Optionally, device display 348B can be a touch sensitive component (e.g., a touch-sensitive display screen or a touch pad) that is sensitive to the touch of an agent input object (e.g., a finger or a stylus), such as that which is described above with respect to display 338B. As is understood, delivery device 340 may provide other suitable methods for providing input to delivery device 340 as well. Moreover, delivery device 340 can include one or more speakers, one or more cameras, or more than one microphones such that delivery device 340 configured with voice control, motion detection, and other functionality.

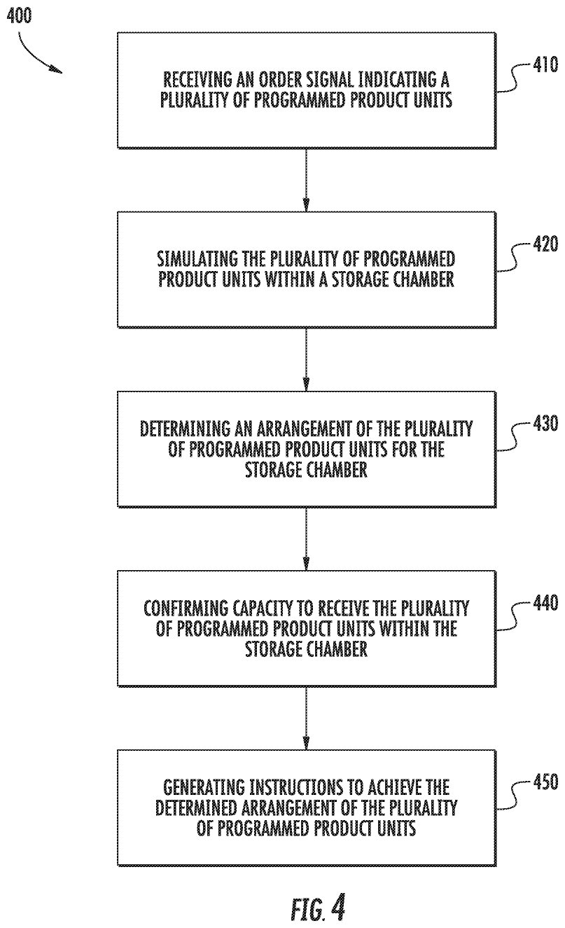

Referring now to FIG. 4, various methods may be provided for use with system 300 in accordance with the present disclosure. In general, the various steps of methods as disclosed herein may, in exemplary embodiments, be performed by remote server 320 as part of an operation that remote server 320 is configured to initiate (e.g., a coordinate delivery operation). During such methods, remote server 320 may receive inputs and transmit outputs from various other components of system 300. For example, remote server 320 may send signals to and receive signals from destination container 110, delivery device 340, or user device 330. In particular, the present disclosure is further directed to methods, as indicated by method 400, for operating system 300. Such methods advantageously facilitate coordinated delivery such that a consumer or delivery agent may verify the capability for securely delivering multiple items even if the consumer is not present.

At 410, the method 400 includes receiving an order signal indicating a plurality of programmed product units. As noted above, the programmed product units may be understood as goods or products offered for sale or delivery. The programmed product units thus correspond to tangible goods or products to be physically delivered to the user or consumer. Information regarding the product units (e.g., size, mass, volume, recommended storage temperature, etc., including the packaging thereof) may be stored or programmed within the remote server. In turn, the remote server may generate or store a virtual, nonphysical model of each product unit of the plurality programmed product units.

The order signal may indicate that a user or consumer intends to purchase, but has not yet purchased, the plurality of programmed product units, such as when product units are added to a virtual “cart” using a retail website or application (i.e., app). For example, the order signal may be received from a user device (e.g., directly or indirectly through an intermediate remote server) prior to the actual purchase (e.g., order confirmation) of the programmed product units.

At 420, method 400 includes simulating the plurality of programmed product units within the storage chamber of the destination container. Generally, 420 occurs apart from the destination container, such as at or within the remote server (e.g., by processors and memory devices of the remote server). For instance, the remote server may generate or store a virtual representation of the destination container within which virtual representations of the product units can be organized. Advantageously, the simulations may occur without requiring a user, consumer, or delivery agent to physically move any item (e.g., an actual product unit, a representative/model product unit, etc.).

As described above, the storage chamber of the destination container may include a plurality of discrete, temperature varied compartments (e.g., freezer compartment, fresh food compartment, or room temperature compartment). Additionally or alternatively, if movable divider liners are provided within the storage chamber, 420 may include simulating movement of the divider liners such that the volume of discrete compartments within the virtual storage chamber is selectively varied. Optionally, 420 may include simulating a temperature distribution within the storage chamber while product units or held therein. In other words, 420 may include predicting the effects to temperature within the storage chamber that are caused by the presence of the product units therein.

At 430, the method 400 includes determining an arrangement of the plurality of programmed product units for the storage chamber. The determination of 430 is based on the simulation of 420. Moreover, the determination of 430 may provide an arrangement of the product units in which each product unit can be held entirely within the storage chamber while the door is in the closed position. In optional embodiments, the determination of 430 is further based on a potential temperature distribution within the storage chamber (e.g., when the product units are placed within the storage chamber). For instance, the determination of 430 may provide an arrangement of the product units that maintains each product unit at a corresponding recommended temperature or temperature range. The determination of 430 may thus require discrete product units are placed within different compartments or sub-portions of a compartment (e.g., closer to or further away from the evaporator of the conditioning assembly mounted to the cabinet). In some such embodiments, the recommended temperature or temperature range for each product unit is programmed or stored within remote server.

At 440, the method 400 includes confirming capacity to receive the plurality of programmed product units in response to 430. In other words, 440 may be contingent upon a suitable arrangement for the programmed product units being determined at 430. Upon confirming capacity, the method 400 may transmit a confirmation signal (e.g., to a user device) or otherwise permit a user to purchase the plurality of programmed product units.

At 450, the method 400 includes generating instructions to achieve the determined arrangement of 430. Generally, the generated instructions may provide multiple structured or sequenced steps that a delivery agent should follow in order to achieve the determined arrangement of 430. The structured or sequenced steps may be steps that the delivery agent is intended to follow prior to or subsequent to arriving at the destination container. As an example, the structured or sequenced steps may be predelivery packaging actions (e.g., steps for physically organizing, storing, or packaging product units together prior to physically reaching the destination container). As another example, the structured or sequenced steps may be steps for placing individual product units within the destination container upon physically reaching the destination container).

The generated instructions may be transmitted from the remote server to, for example, a delivery device, printer, the destination container (e.g., directly or indirectly through an intermediate device, such as a user device), or other location such that a delivery agent may receive the generated instructions without being in close proximity to the remote server (e.g., within the same building or enclosed structure as the remote server, within 100 meters of the remote server, etc.). The generated instructions may be provided in any suitable form for explaining the structured sequenced steps that the delivery agent should follow. As an example, the generated instructions may include instructional images (e.g., static images or, alternatively, a dynamic series of images, such as video) providing a two-dimensional representation for how the product units must be placed within the destination container. As another example, the generated instructions may include instructional text providing a written description for how the product units must be placed within the destination container.

Prior to or subsequent to 450, the method 400 may include determining a target temperature for the storage chamber. The target temperature may be determined as or based on, for instance, a recommended temperature of one or more of the programmed product units. Additionally or alternatively, the target temperature may be based on a simulated temperature distribution for the destination container when the programmed product units are positioned in the determined arrangement of 430. In some such embodiments, the simulations of 420 may include simulating temperature effects caused by one or more arrangements of the programmed product units within the storage chamber. Further additionally or alternatively, the target temperature may be based on weather information or data, such as an actual or predicted ambient temperature (e.g., received from another remote server or directly from destination container). Still further, the target temperature may be based on a predicted delivery time such that the target temperature is achieved within the destination container at or prior to the predicted delivery time.

In some embodiments, the target temperature signal is received by the destination container and initiates an automatic temperature adjustment at the conditioning assembly (e.g., without requiring input or engagement from a user or delivery agent). In alternative embodiments, the target temperature signal may be transmitted to the destination container, a user device, or a delivery device; and a user, consumer, or delivery agent may be directed (e.g., instructed) to manually adjust the temperature within the storage chamber (e.g., by selecting the target temperature at the user interface panel).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of coordinating consumer delivery to a destination container comprising a cabinet defining a storage chamber in thermal communication with a conditioning assembly mounted to the cabinet, the method comprising:
receiving an order signal indicating a plurality of programmed product units;
simulating, apart from the destination container, the plurality of programmed product units within the storage chamber;
determining, apart from the destination container, an arrangement of the plurality of programmed product units for the storage chamber based on simulating the plurality of programmed product units; and
generating instructions for the determined arrangement of the plurality of programmed product units.

2. The method of claim 1, wherein the storage chamber comprises a plurality of discrete, temperature-varied compartments.

3. The method of claim 1, wherein determining the arrangement of the plurality of programmed product units is further based on a potential temperature distribution within the storage chamber.

4. The method of claim 3, wherein the storage chamber comprises a freezer compartment and a fresh food compartment.

5. The method of claim 1, further comprising transmitting a target temperature signal for the storage chamber based on the plurality of programmed product units.

6. The method of claim 5, wherein the target temperature signal is transmitted to the destination container.

7. The method of claim 6, wherein the target temperature signal initiates a temperature adjustment at the conditioning assembly of the destination container.

8. The method of claim 1, further comprising transmitting the generated instructions to a delivery device comprising a device display for viewing the generated instructions.

9. The method of claim 1, wherein the generated instructions comprise instructional images.

10. The method of claim 1, wherein the generated instructions comprise instructional text.

11. The method of claim 1, wherein the generated instructions comprise instructions of pre-delivery packaging actions.

12. A method of coordinating consumer delivery to a destination container comprising a cabinet defining a storage chamber in thermal communication with a conditioning assembly mounted to the cabinet, the method comprising:
receiving an order signal indicating a plurality of programmed product units;
simulating, apart from the destination container, the plurality of programmed product units within the storage chamber;
determining, apart from the destination container, an arrangement of the plurality of programmed product units for the storage chamber based on simulating the plurality of programmed product units;
confirming capacity to receive the plurality of programmed product units within the storage chamber in response to determining the arrangement; and
generating instructions for the determined arrangement of the plurality of programmed product units.

13. The method of claim 12, wherein the storage chamber comprises a plurality of discrete, temperature-varied compartments.

14. The method of claim 12, wherein determining the arrangement of the plurality of programmed product units is further based on a potential temperature distribution within the storage chamber.

15. The method of claim 12, further comprising transmitting a target temperature signal for the storage chamber based on the plurality of programmed product units.

16. The method of claim 15, wherein the target temperature signal initiates a temperature adjustment at the conditioning assembly of the destination container.

17. The method of claim 12, further comprising transmitting the generated instructions to a delivery device comprising a device display for viewing the generated instructions.

18. The method of claim 12, wherein the generated instructions comprise instructional images.

19. The method of claim 12, wherein the generated instructions comprise instructional text.

20. The method of claim 12, wherein the generated instructions comprise instructions of pre-delivery packaging actions.
